(19) United States
(12) Patent Application Publication
(10) Pub. No.: US 2007/0108246 A1
(43) Pub. Date: May 17, 2007

(54) Extendible hauling rack

(76) Inventors: Bill J. Jennings, Tyler, TX (US); M.J. Taylor Jennings, Tyler, TX (US)

Correspondence Address: Galasso & Associates, LP, P.O. Box 26503, Austin, TX, 78755-0503, US

(21) Appl. No.: 11/274,469

(22) Filed: Nov. 15, 2005

(51) Int. Cl. B60R 9/00; B60R 11/00

(52) U.S. Cl. 224/521; 224/519

(57) ABSTRACT

An extendible hauling rack is provided to expand the hauling capacity of vehicles with roof racks. A user places the extendible rack's hitch receiver mount over a trailer hitch on the rear bumper of a vehicle and locks the lock on the hitch receiver mount so that the trailer hitch is securely fastened in place. The user then typically removes a sliding pin on a sliding extension on the extendible rack and raises or lowers the sliding extension to the correct height so that the support bars on the extendible rack provide a level surface matching the height of the hauling rack on the vehicle. The user reinserts the sliding pin through a hole in the base of the extendible rack and the height adjustment hole for that height on the sliding extension. A spring-loaded button may also be used to fasten the sliding extension adjustably to the base.

### FIELD OF THE DISCLOSURE

This invention relates generally to hauling racks and more particularly to an extendible hauling rack for use with vehicles that have roof racks.

### BACKGROUND

Most cars, trucks, SUVs (sport-utility vehicles) and vans are marketed with sets of features that satisfy the average consumer. In addition, owners of motor vehicles often employ accessories to expand the functionality of their vehicles for increased utility, personal comfort, additional electronic entertainment options, and extra power equipment. One popular accessory for vans and SUVs is the roof rack, which allows a van or SUV to haul cargo on the roof of the vehicle. One disadvantage of a roof rack is that it provides only a limited area of use. Cargo that extends significantly longer than a roof rack, such as long lumber or pipes, may have unsupported and unsecured portions, which may be dangerous or awkward to haul. A user may have to employ a trailer instead of the roof rack to haul such cargo, which can add to the expense or inconvenience of the hauling.

Devices for expanding the hauling capacity of vehicles are known in the art. For example, U.S. Pat. No. 6,059,339 for Madson provides an extendible platform for the boxes of pickup trucks, and U.S. Pat. No. 5,458,389 for Young provides an adjustable bed extender for vehicles with beds. But such devices are not typically designed specifically for use with hauling racks, such as those used on vans and SUVs, which can make these devices difficult or impossible to use with hauling racks on these vehicles.

Therefore, there is a need for an extendible hauling rack that can be used with vehicles equipped with roof racks.

### SUMMARY OF THE DISCLOSURE

The following explanation describes the present invention by way of example and not by way of limitation.

It is an aspect of the present invention to provide an extendible hauling rack that can be used with vehicles equipped with roof racks.

It is another aspect of the present inventions to provide means of adjustably fastening a sliding extension and a base on an extendible hauling rack.

These and other aspects of the present invention will become readily apparent upon further review of the following specification and associated drawings. In accordance with the present invention, an extendible hauling rack is provided to expand the hauling capacity of vehicles with roof racks. A user places the extendible rack's hitch receiver mount over a trailer hitch on the rear bumper of a vehicle and locks the lock on the hitch receiver mount so that the trailer hitch is securely fastened in place. The user then typically removes a sliding pin on a sliding extension on the extendible rack and raises or lowers the sliding extension to the correct height so that the support bars on the extendible rack provide a level surface matching the height of the hauling rack on the vehicle. The user reinserts the sliding pin through a hole in the base of the extendible rack and the height adjustment hole for that height on the sliding extension. A spring-loaded button may also be used to fasten the sliding extension adjustably to the base.

### BRIEF DESCRIPTION OF THE DRAWINGS

The following embodiments of the present invention are described by way of example only, with reference to the accompanying drawings, in which:

FIG. 1 is a block diagram that illustrates an extendible hauling rack; and

FIG. 2 is a block diagram that illustrates a side view of the telescoping steel tubing of an extendible hauling rack.

### DETAILED DESCRIPTION OF THE DRAWING FIGURES

The following description of drawings is offered to illustrate the present invention clearly. However, it will be apparent to those skilled in the art that the concepts of the present invention are not limited to these specific details. Also, commonly known elements are shown in diagrams for clarity, as examples only and not as limitations of the present invention.

The present invention comprises an extendible hauling rack for vehicles equipped with roof racks, such as vans and SUVs. In an embodiment, the extendible hauling rack is constructed of non-corrosive, durable, and strong metal, which has high impact strength and can accept and retain coloring materials for an extended length of time. For example, steel or alloys of steel and aluminum may be used. In an embodiment, the extendible hauling rack is constructed of square steel tubing.

The extendible hauling rack is T-shaped and measures approximately fifty-five inches to sixty-nine inches in length and thirty inches in width. The length is adjustable to accommodate different vehicles.

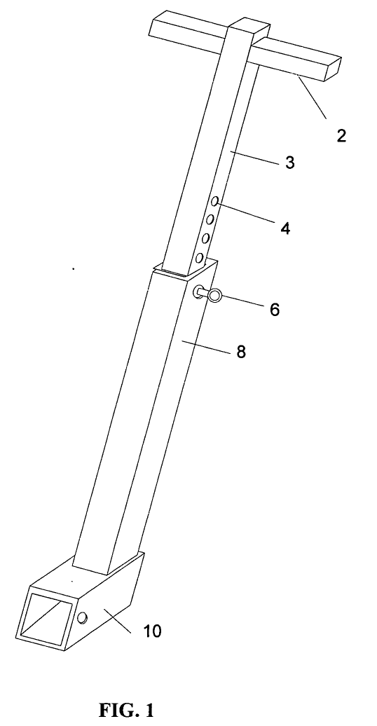

As shown in FIG. 1, the extendible hauling rack comprises the following elements:
Support bars 2,
A sliding extension 3,
Height adjustment holes 4,
A securing pin 6,
A base 8,
A hitch receiver mount 10, and
A cotter pin 12.

The support bars 2 provide a supporting surface onto which the end portions of objects to be hauled may be placed when the objects extend beyond the length of a vehicle's hauling rack. In an embodiment, the combined support bars 2 measure approximately thirty inches in width and may be constructed of one and one-half inch square tubing.

The support bars 2 are attached securely, for example by welding, to a sliding extension 3 that fits into a base 8. The sliding extension 3 and base 8 comprise telescoping steel tubing, which in an embodiment measures approximately three sixteenths of an inch in thickness. The sliding extension 3 may be constructed of one and one-half inch square steel tubing. The base 8 may be constructed of two-inch square steel tubing.

The base 8 inserts into a hitch receiver mount 10 and lock. In an embodiment, the hitch receiver mount 10 measures approximately twelve inches in length and may be constructed of three-inch square steel tubing. In another embodiment the hitch receiver mount 10 may be constructed of two-inch square steel tubing and is welded to the base 8.

Height adjustment holes 4 in the sliding extension 3 allow the sliding extension 3 to be attached securely to the base 8 in different positions to provide level surfaces matching the heights of hauling racks on different vehicles. In an embodiment, a sliding pin 6 may be inserted through a hole in the base 8 and a matching height adjustment hole 4 in the sliding extension 3 to hold the sliding extension 3 in place. In another embodiment, a spring-loaded button on the base locks into one of the height adjustment holes 4 on the sliding extension 3 to hold the sliding extension 3 in place.

Use

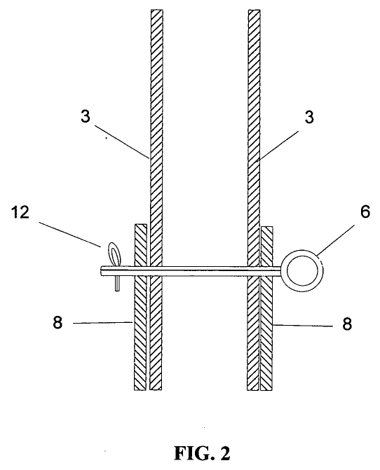

A user places the hitch receiver mount 10 over a trailer hitch on the rear bumper of a vehicle and locks the lock on the hitch receiver mount so that the trailer hitch is securely fastened in place, as is well known to those skilled in the art. The user then removes the sliding pin 6 and raises or lowers the sliding extension 3 to the correct height so that the support bars 2 provide a level surface matching the height of the hauling rack on the vehicles. The user then reinserts the sliding pin 6 through the height adjustment hole 4 for that height on the sliding extension 3. As shown in FIG. 2, the sliding pin 6 is placed through holes passing entirely through the sliding extension 3 and base 8 and may be held securely in place by the insertion of a cotter pin 12. In another embodiment, a spring-loaded button on the base 8 is used to lock into a height adjustment hole 4 to hold the sliding extension 3 in place After the extendible hauling rack is in the correct position, the use places cargo on the vehicle's roof rack, with the rear portion of that cargo on the supporting bars 2 of the extendible hauling rack, and secures the cargo for hauling with rope or other means.

The best dimensional relationships for the parts of the invention described above, including variations in form and use, will be readily apparent to those skilled in the art, and are intended to be encompassed by the present invention.

What is claimed is:

1. An extendible hauling rack for expanding the hauling capacity of vehicles with roof racks, the extendible hauling rack comprising
support bars,
a sliding extension, wherein the sliding extension comprises
height adjustment holes,
means for attaching the support bars securely to the sliding extension,
a base,
means for adjustably fastening the sliding extension to the base,
a hitch receiver mount, such that the hitch receiver
mounts over a trailer hitch, and
comprises a lock.

2. The support bars of claim 1, wherein the support bars comprise one and one-half inch square tubing.

3. The support bars of claim 1, wherein the combined support bars measure thirty inches in width.

4. The sliding extension of claim 1, wherein the sliding extension forms telescoping tubing with the base.

5. The sliding extension of claim 1, wherein the sliding extension comprises one and one-half inch square steel tubing.

6. The means for attaching the support bars securely to the sliding extension of claim 1, wherein the means for attaching the support bars securely to the sliding extension comprises welding.

7. The base of claim 1, wherein the base comprises two-inch square steel tubing.

8. The means for adjustably fastening the sliding extension to the base of claim 1, wherein the means for adjustably fastening the sliding extension to the base comprises
a sliding pin, and
a hole through two opposing sides of the base.

9. The means for adjustably fastening the sliding extension to the base of claim 1, wherein the means for adjustably fastening the sliding extension to the base comprises a spring-loaded button.

10. An extendible hauling rack for expanding the hauling capacity of vehicles with roof racks, the extendible hauling rack comprising
support bars, wherein the support bars
comprise one and one-half inch square tubing;
measure thirty inches in combined width; and
are welded securely to the sliding extension;
a sliding extension, wherein the sliding extension
comprises
height adjustment holes, and
one and one-half inch square steel tubing; and
forms telescoping tubing with the base, such that the telescoping tubing is extendible to sixty-nine inches in length;
a base, wherein the base comprises two-inch square steel tubing;
means for adjustably fastening the sliding extension to the base, wherein the means for adjustably fastening the sliding extension to the base comprises
a sliding pin; and
a hole through two opposing sides of the base; and
a hitch receiver mount, such that the hitch receiver
mounts over a trailer hitch, and
comprises a lock.

11. An extendible hauling rack for expanding the hauling capacity of vehicles with roof racks, the extendible hauling rack comprising
support bars, wherein the support bars
comprise one and one-half inch square tubing;
measure thirty inches in combined width, and
are welded securely to the sliding extension;
a sliding extension, wherein the sliding extension
comprises
height adjustment holes, and
one and one-half inch square steel tubing; and
forms telescoping tubing with the base, such that the telescoping tubing is extendible to sixty-nine inches in length;
a base, wherein the base comprises two-inch square steel tubing;
means for adjustably fastening the sliding extension to the base, wherein the means for adjustably fastening the sliding extension to the base comprises a spring-loaded button; and
a hitch receiver mount, such that the hitch receiver
mounts over a trailer hitch; and
comprises a lock.
